(19) United States
(12) Patent Application Publication
(10) Pub. No.: US 2016/0027031 A1
(43) Pub. Date: Jan. 28, 2016

(54) Methods and Systems for Managing Social Media Contents

(71) Applicants: Alen Stephan Bubic, Toronto (CA); Shaun Michael Nilsson, New York, NY (US)

(72) Inventors: Alen Stephan Bubic, Toronto (CA); Shaun Michael Nilsson, New York, NY (US)

(21) Appl. No.: 14/807,005

(22) Filed: Jul. 23, 2015

Related U.S. Application Data
(60) Provisional application No. 62/027,956, filed on Jul. 23, 2014.

(51) Int. Cl. G06Q 30/02; G06Q 10/02; G06Q 50/00; H04L 29/08

(52) U.S. Cl. CPC G06Q 30/0214; H04L 67/22; G06Q 30/0269; G06Q 30/0242; G06Q 10/02; G06Q 50/01

(57) ABSTRACT

Methods and systems are provided for managing social media contents. The methods and systems involve automatically distributing social media contents to certain social media accounts. An example method involves receiving a subscription request from a subscribing user requesting for social media contents, tracking an interaction with interfaces displaying the relevant social media contents, and generating an interaction tool in response to an event caused by the interaction. The interaction tool can be a form component or a transaction component for receiving inputs from a visitor to the interfaces. Another example method involves receiving a distribution authorization from a secondary user that authorizes a primary user to distribute social media content on his/her behalf. Any transaction resulting from the social media content being distributed to the secondary user's account will be attributed to the secondary user.

### CROSS-REFERENCE TO RELATED APPLICATIONS

This application claims the benefit of U.S. Provisional Application No. 62/027,956, entitled “METHODS AND SYSTEMS FOR MANAGING SOCIAL MEDIA CONTENTS”, filed Jul. 23, 2014. The entire content of U.S. Provisional Application No. 62/027,956 is hereby incorporated by reference.

### FIELD

The described embodiments relate to methods and systems for managing social media contents and in particular, managing the social media contents based, at least, on user interaction with the social media contents.

### BACKGROUND

Social media networks are typically characterized by large and evolving communities. A user account within a social media network is likely connected with other users within that social media network. The connections may be based on existing real-world relationships, such as family members, friends, co-workers, and classmates, or based on a shared interest. A user can control the connections that are made, and the number of connections that can be made by the user is typically unrestricted.

When a social media message is posted on a user account, that social media message will be available to the connections and/or networks selected by the user. Since the connections and networks are typically based on some existing relationship or common interest, the social media message is likely to be received by a relatively captive and interested audience. As a result, social media networks can be an effective platform for mass content distribution.

Although social media networks provide a platform for mass content distribution, the generation of the social media content by existing systems still relies on some involvement, direct or indirect, by users and so, the effectiveness of a user account on any social media network continues to rely, at least, on the ability of that user to create a social media presence and to maintain that social media presence. The success of one's social media presence can also depend, to a degree, on viewer response to the social media contents. Businesses, for example, may rely on their presence on social media networks for collecting leads and contacts. Therefore, although social media networks can serve as a platform for mass content distribution, further engagement of the viewers who are likely more interested in the social media content can be difficult.

### SUMMARY

The various embodiments described herein generally relate to methods (and associated systems configured to implement the methods) for managing social media contents.

In accordance with some embodiments, a method for managing social media contents includes: receiving a subscription request from a subscribing user, the subscription request comprising at least a category of the social media content and account data for a set of social media accounts associated with the subscribing user; automatically distributing, without additional input from the subscribing user, at least one social media content to at least one social media account of the set of social media accounts, the at least one social media content being associated with the category; tracking an interaction with a user interface associated with the at least one social media account, the interaction being conducted by a visitor navigating the user interface; generating an interaction tool in response to an event caused by the interaction, the interaction tool comprising at least one of (i) a form component for receiving user data from the visitor and (ii) a transaction component for receiving transaction data from the visitor for conducting a transaction; and attributing use of the interaction tool by the visitor.

In some embodiments, the subscription request includes a subscription level of the subscribing user; and attributing the use of the interaction tool by the visitor includes selecting a beneficiary based on, at least, the subscription level of the subscribing user. The beneficiary can be selected from a group consisting of the subscribing user, a second subscribing user, and a content provider providing the social media contents.

In some embodiments, the interaction tool is the form component, the form component including one or more data fields for receiving the user data from the visitor and the user data including, at least, contact information of the visitor; the subscription level comprises a referral level, the referral level indicating the subscribing user is interested in receiving leads data and the leads data comprises the user data for the visitors who are potential leads for the subscribing user; and attributing the use of the interaction tool by the visitor includes: in response to determining the subscription level of the subscribing user is the referral level, selecting the subscribing user as the beneficiary; and forwarding the user data as the leads information for the subscribing user.

In some embodiments, the interaction tool is the transaction component; the subscription level comprises a user commission level, the user commission level indicating the subscribing user receives a commission from the transaction; and attributing the use of the interaction tool by the visitor includes: in response to determining the subscription level of the subscribing user is the user commission level, selecting the subscribing user as the beneficiary.

In some embodiments, the event comprises an interaction threshold; and generating the interaction tool in response to the event caused by the interaction includes: detecting the interaction satisfies the interaction threshold; and providing the interaction tool on a display providing the user interface. The interaction threshold can include at least a revisit threshold, the revisit threshold corresponding to a minimum number of visits by the visitor to the user interface before the interaction tool is generated.

In accordance with some embodiments, a system for managing social media contents includes a processor module configured to: receive a subscription request from a subscribing user, the subscription request comprising at least a category of the social media content and account data for a set of social media accounts associated with the subscribing user; automatically distribute, without additional input from the subscribing user, at least one social media content to at least one social media account of the set of social media accounts, the at least one social media content being associated with the category; track an interaction with a user interface associated with the at least one social media account, the interaction being conducted by a visitor navigating the user interface; generate an interaction tool in response to an event caused by the interaction, the interaction tool comprising at least one of (i) a form component for receiving user data from the visitor and (ii) a transaction component for receiving transaction data from the visitor for conducting a transaction; and attribute use of the interaction tool by the visitor.

In some embodiments, the subscription request comprises a subscription level of the subscribing user; and the processor module is configured to select a beneficiary based on, at least, the subscription level of the subscribing user. The beneficiary can be selected from a group consisting of the subscribing user, a second subscribing user, and a content provider providing the social media contents.

In some embodiments, the interaction tool is the form component, the form component including one or more data fields for receiving the user data from the visitor and the user data including, at least, contact information of the visitor; the subscription level comprises a referral level, the referral level indicating the subscribing user is interested in receiving leads data and the leads data comprises the user data for the visitors who are potential leads for the subscribing user; and the processor module is configured to: in response to determining the subscription level of the subscribing user is the referral level, select the subscribing user as the beneficiary; and forward the user data as the leads information for the subscribing user.

In some embodiments, the interaction tool is the transaction component; the subscription level comprises a user commission level, the user commission level indicating the subscribing user receives a commission from the transaction; and the processor module is configured, in response to determining the subscription level of the subscribing user is the user commission level, select the subscribing user as the beneficiary.

In some embodiments, the event comprises an interaction threshold; and the processor module is configured to: detect the interaction satisfies the interaction threshold; and provide the interaction tool on a display providing the user interface. The interaction threshold includes at least a revisit threshold, the revisit threshold corresponding to a minimum number of visits by the visitor to the user interface before the interaction tool is generated.

In accordance with some other embodiments, a method for managing social media contents includes: receiving a distribution authorization from a secondary user, the distribution authorization providing a primary user with permission to distribute the social media content to a set of social media accounts associated with the secondary user and the secondary user being in a hierarchical relationship with the primary user; in response to receiving the distribution authorization, automatically distributing, without additional input from the secondary user, at least one social media content to at least one social media account of the set of social media accounts; receiving a transaction input from a visitor via a user interface displaying data associated with the at least one social media account, the visitor being a user navigating the user interface and the transaction input being associated with the at least one social media content; and in response to receiving the transaction input, conducting a transaction in accordance with the transaction input and the at least one social media content, wherein conducting the transaction comprises attributing the transaction to the secondary user.

In some embodiments, attributing the transaction to the secondary user comprises apportioning a portion of a transaction amount to the secondary user.

In some embodiments, the social media content comprises content associated with a marketing campaign for the primary user.

In some embodiments, the marketing campaign involves an advertisement of a product; the transaction input comprises a purchase request for the product; and conducting the transaction comprises: fulfilling the purchase request; and apportioning a portion of a purchase amount to the secondary user.

In some embodiments, the marketing campaign involves an advertisement of an event; the transaction input comprises at least one of a purchase request associated with the event and a reservation request for the event; and conducting the transaction comprises: fulfilling the at least one of the purchase request and the reservation request; and apportioning a portion of a transaction amount to the secondary user.

In some embodiments, the primary user is an employer of the secondary user.

In accordance with some embodiments, a system for managing social media contents includes a processor module configured to: receive a distribution authorization from a secondary user, the distribution authorization providing a primary user with permission to distribute the social media content to a set of social media accounts associated with the secondary user and the secondary user being in a hierarchical relationship with the primary user; in response to receiving the distribution authorization, automatically distribute, without additional input from the secondary user, at least one social media content to at least one social media account of the set of social media accounts; receive a transaction input from a visitor via a user interface displaying data associated with the at least one social media account, the visitor being a user navigating the user interface and the transaction input being associated with the at least one social media content; and in response to receiving the transaction input, conduct a transaction in accordance with the transaction input and the at least one social media content, wherein the processor module is configured to conduct the transaction by attributing the transaction to the secondary user.

In some embodiments, the processor module is configured to apportion a portion of a transaction amount to the secondary user.

In some embodiments, the social media content comprises content associated with a marketing campaign for the primary user.

In some embodiments, the marketing campaign can involve an advertisement of a product; the transaction input comprises a purchase request for the product; and the processor module is configured to: fulfill the purchase request; and apportion a portion of a purchase amount to the secondary user.

In some embodiments, the marketing campaign involves an advertisement of an event; the transaction input comprises at least one of a purchase request associated with the event and a reservation request for the event; and the processor module is configured to: fulfill the at least one of the purchase request and the reservation request; and apportion a portion of a transaction amount to the secondary user.

In some embodiments, the primary user is an employer of the secondary user.

### BRIEF DESCRIPTION OF THE DRAWINGS

Several embodiments will now be described with reference to the drawings, in which:

FIG. 1 is a block diagram of components interacting with a content system in accordance with an example embodiment;

FIG. 2 is a flowchart of an example embodiment of various methods of managing social media contents;

FIG. 3 is a screenshot of a user interface for receiving a subscription request in accordance with an example embodiment;

FIGS. 4A and 4B are screenshots of user interfaces for different social media accounts in accordance with an example embodiment;

FIG. 4C is a screenshot of the user interface of FIG. 4B showing an interaction tool in accordance with an example embodiment;

FIG. 5 is a flowchart of another example embodiment of the various methods of managing social media contents;

FIG. 6 is a screenshot of a user interface for receiving a distribution authorization in accordance with an example embodiment;

FIGS. 7A and 7B are screenshots of user interfaces for different social media accounts in accordance with another example embodiment; and

FIG. 7C is a screenshot of a user interface for receiving transaction data in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to methods (and associated systems configured to implement the methods) for managing social media contents. Social media contents can include any posting distributed to a social media account within a social media network. The posting can include various types of data, including text, graphics, videos, Uniform Resource Locators (URLs), a combination of one or more of these types of data, and/or other similar types of data.

Social media networks can be characterized by large and evolving communities, with each user account likely connected with multiple other users. The connections may be based on existing real-world relationships, such as family members, friends, co-workers, and classmates, or based only on a shared interest (e.g., a sport or a sport team, a travel destination, a store or brand, similar personal experiences, etc.). Although the connections on social media networks may include less tangible relationships, such as purely virtual relationships, the social media content distributed by social media connections tend to be more influential and trusted than content received from sources outside the social media networks, such as third-party advertisers. The link that led to the formation of the social media connections appears to increase the merit of the social media contents.

Therefore, it may sometimes be beneficial for certain users, such as entities, to take advantage of the social media accounts of other users. Some methods and systems described herein can involve receiving a distribution authorization from a user (a secondary user) who is in a hierarchical relationship with another user (a primary user), and automatically distributing social media content to the social media account of the secondary user.

For example, the primary user may be an employer and the secondary user may be an employee. In this example application of some of the described systems and methods, employers can benefit from being able to distribute social media messages to the social media networks of its employees on behalf of those employees. The users within the social media networks of the employees are more likely to be interested in the social media contents generated by that employer since the employee likely has some common interests with those connections. Also, if there are no existing connections between the employer and the users within the social media networks of the employees, it is likely that the users within the social media networks of the employees will be more receptive to the social media content distributed via the employees' social media accounts than the social media content distributed via the employers' social media accounts.

It will be understood that the described systems and methods may similarly apply to relationships other than the employer-employee example described above.

When the distribution authorization is received, the described systems may automatically distribute social media content to the social media accounts of the secondary user (e.g., employees). The described systems may also receive a transaction input from a visitor of the secondary user's social media account for conducting a transaction associated with the social media content distributed by the primary user. The secondary user may then benefit from the distribution of the social media content to his or her social media content by being attributed to the transaction. As a result, both the primary user and the secondary user can benefit, with minimal actions, from the use of the secondary user's social media account as a platform for mass content distribution.

As noted, social media networks can serve as platforms for mass content distribution. However, in the prior systems, the generation of social media content still requires some involvement, direct or indirect, by the respective users and so, the effectiveness of a user account on any social media network continues to rely, at least, on the ability of that user to create a social media presence and to maintain that social media presence. The success of the social media account can also depend, to a degree, on viewer response to the social media content.

The use of social media has evolved. Social media began as a virtual forum for individuals to communicate and interact as a community. As social media networks increased in prominence, their use expanded. For instance, social media networks are now increasingly used as a forum for entities (e.g., businesses, clubs, etc.) and individuals (e.g., politicians, celebrities, etc.) to promote themselves and/or associated events and products. Businesses, for example, may rely on their presence on social media networks for collecting leads. Therefore, further engagement of certain viewers of the social media content may be helpful.

Some of the methods and systems described herein can include automatically distributing social media content to a social media account and tracking an interaction with the social media account. Various interactions may be tracked. For example, a navigation of the user interface displaying the social media account and a number of revisits to the social media account by the same visitor may be interactions. Depending on the interaction, the described systems may generate an interaction tool for obtaining further information from the visitor or for conducting a transaction.

For example, the described systems may generate the interaction tool when the interaction satisfies a predefined threshold, such as a predefined number of revisits to the social media account, or a length of time that the visitor views the social media account or portions of the social media account. Based on these interactions, the described systems may determine that the visitor may be interested in receiving further information on certain aspects of the social media contents provided on the social media account or in conducting a particular transaction. The described systems can then generate the interaction tool accordingly.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors.

The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

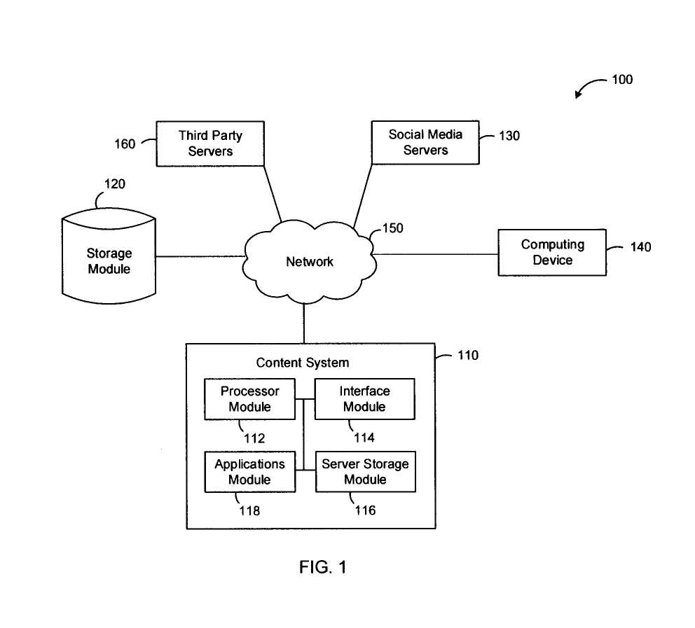

Reference is first made to FIG. 1, which illustrates a block diagram 100 of components interacting with a content system 110 via a network 150. The components include a storage module 120, social media servers 130, computing devices 140, and third party servers 160.

The content system 110 includes a processor module 112, an interface module 114, a server storage module 116 and an applications module 118.

It will be understood that, in some embodiments, each of the processor module 112, the interface module 114, the server storage module 116 and the applications module 118 may be combined into fewer number of modules or may be separated into further modules. Furthermore, the processor module 112, the interface module 114, the server storage module 116 and the applications module 118 may be implemented in software or hardware, or a combination of software and hardware.

Generally, the processor module 112 may be any suitable processors, controllers or digital signal processors that can provide sufficient processing power depending on the configuration, purposes and requirements of the content system 110. In some embodiments, the processor module 112 can include more than one processor with each processor being configured to perform different dedicated tasks.

The processor module 112 may be configured to control the operation of the content system 110. The processor module 112 can initiate and manage the operations of each of the other modules in the content system 110. The processor module 112 may also determine, based on received data, stored data and/or user preferences, how the content system 110 may generally operate.

For example, the processor module 112 may be configured to initiate the applications module 118 to track an interaction with a user interface displaying a social media account, and to generate an interaction tool in certain circumstances. The processor module 112 may also be configured to initiate the applications module 118 to conduct a transaction depending on the use of the content system 110.

The interface module 114 may be any interface that enables the content system 110 to communicate with other devices and systems. In some embodiments, the interface module 114 can include at least one of a serial port, a parallel port or a USB port. The interface module 114 may also include at least one of an Internet, Local Area Network (LAN), Ethernet, Firewire, modem or digital subscriber line connection. Various combinations of these elements may be incorporated within the interface module 114.

For example, the interface module 114 may receive input from various input devices, such as a mouse, a keyboard, a touch screen, a thumbwheel, a track-pad, a track-ball, a card-reader, voice recognition software and the like depending on the requirements and implementation of the content system 110.

The server storage module 116 can include RAM, ROM, one or more hard drives, one or more flash drives or some other suitable data storage elements such as disk drives, etc. The server storage module 116 may further include one or more databases (not shown) for storing data associated with the operation of the described systems and methods.

The storage module 120 may similarly include data storage elements for storing data associated with the operation of the described systems and methods. The storage module 120 can be separate from the content system 110 and accessible via the network 150. It will be understood that although only one storage module 120 is shown, further storage modules 120 may be provided.

For example, the server storage module 116 may store information relating to subscribers and subscription requests. The subscription requests may include data associated with a category of the social media content being requested and account data for the social media accounts that are to receive the social media contents. The server storage module 116 may also store information relating to the interaction thresholds and interaction tools, such as the interaction types and corresponding predefined threshold values. Other information stored at the server storage module 116 may relate to the distribution authorization and to the various primary and secondary users.

Some of the data stored at the server storage module 116 may instead be stored in the storage module 120. In some embodiments, certain critical data may be stored at both the server storage module 116 and the storage module 120.

The applications module 118 can include various application programs involved in the described methods and systems. An interaction application may be provided in the applications module 118 for facilitating the generation of the interaction tool. The interaction application may also determine who to attribute the use of the interaction tool. The applications module 118 may similarly include a transaction application for facilitating a transaction initiated via a user interface of a social media account, and attributing the transaction accordingly.

Each of the computing devices 140 may be any networked device operable to connect to the network 150. A networked device is a device capable of communicating with other devices through a network, such as the network 150, via a wired or wireless connection. It will be understood that although only one computing device is shown in FIG. 1, a greater number of computing devices 140 can connect to the network 150.

As noted, these computing devices 140 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The network 150 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the content system 110, the storage module 120, the social media servers 130, the computing devices 140 and the third party servers 160.

The social media servers 130 can include any computer servers that operate to provide social media applications, such as, but not limited to, Facebook™, Twitter™ and LinkedIn™. It will be understood that each social media server 130 may include one or more servers that may be distributed over a wide geographic area and connected via the network 150.

The third party servers 160 may include any computer servers that operate to provide some other application, such as to facilitate a transaction. The computer servers include one or more processors with computing processing abilities and memory such as a database(s) or file system(s). It will be understood that each third party server 160 may include one or more servers that may be distributed over a wide geographic area and connected via the network 150.

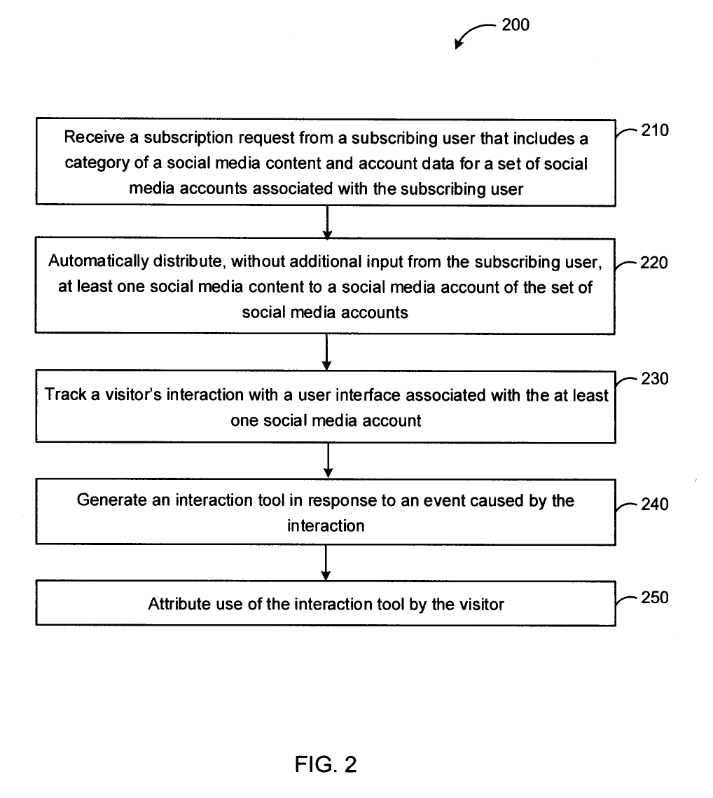

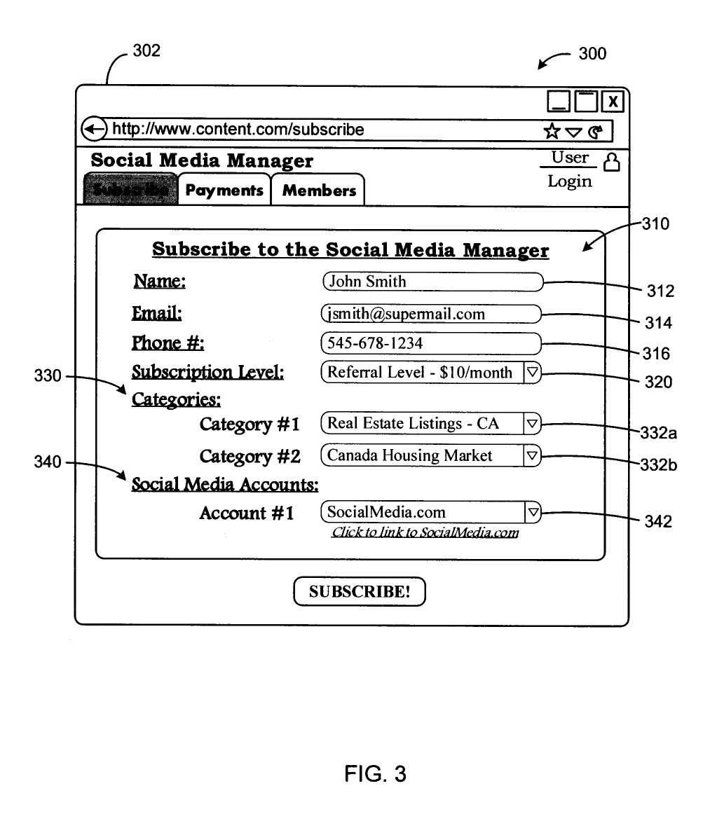

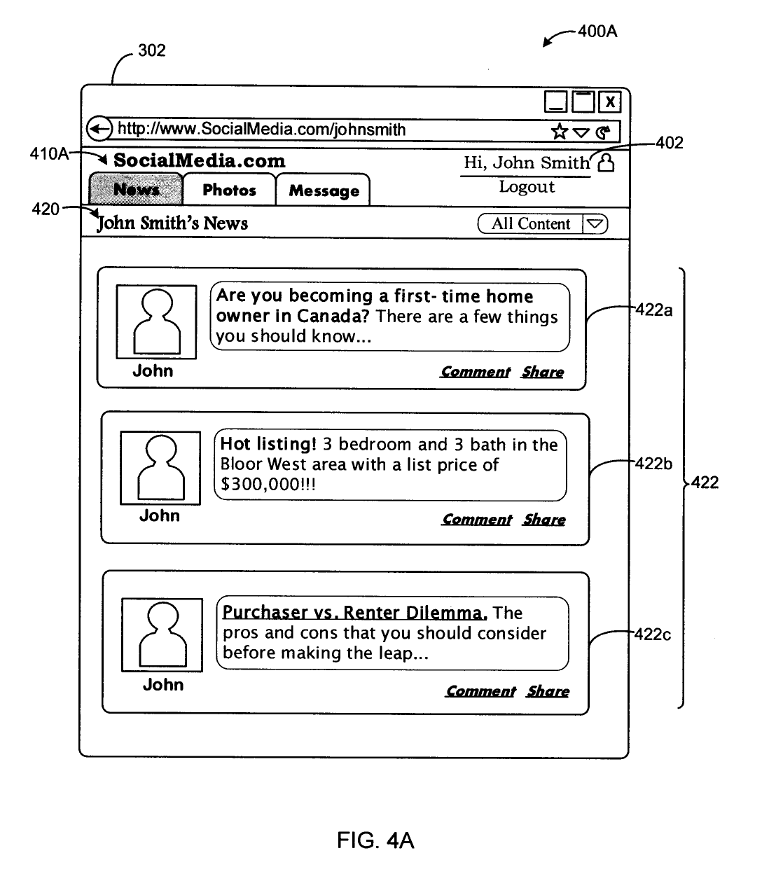

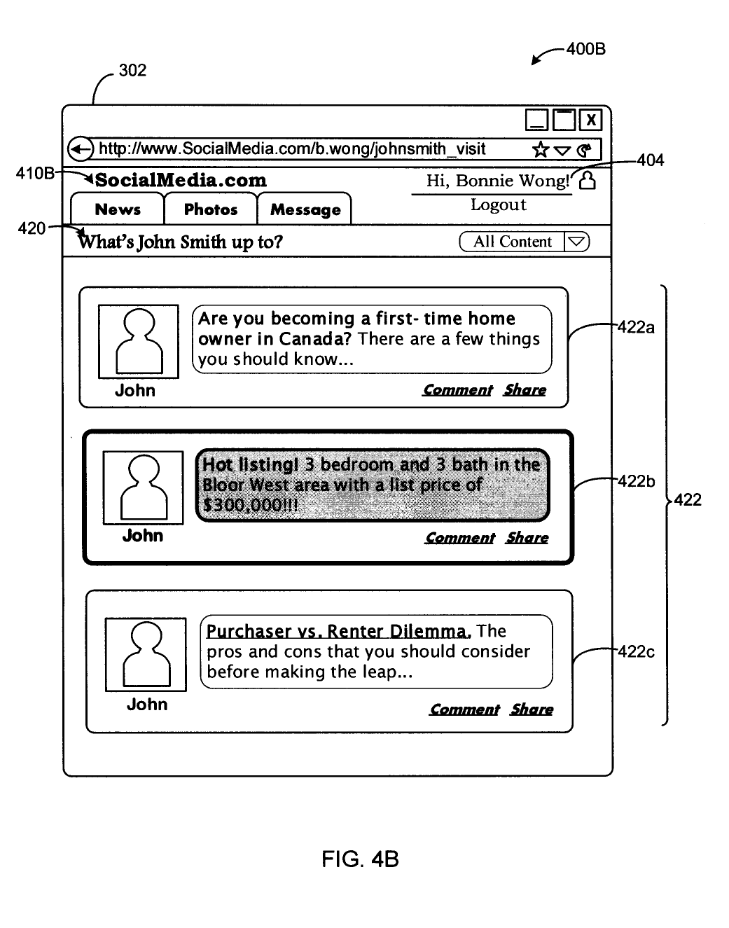

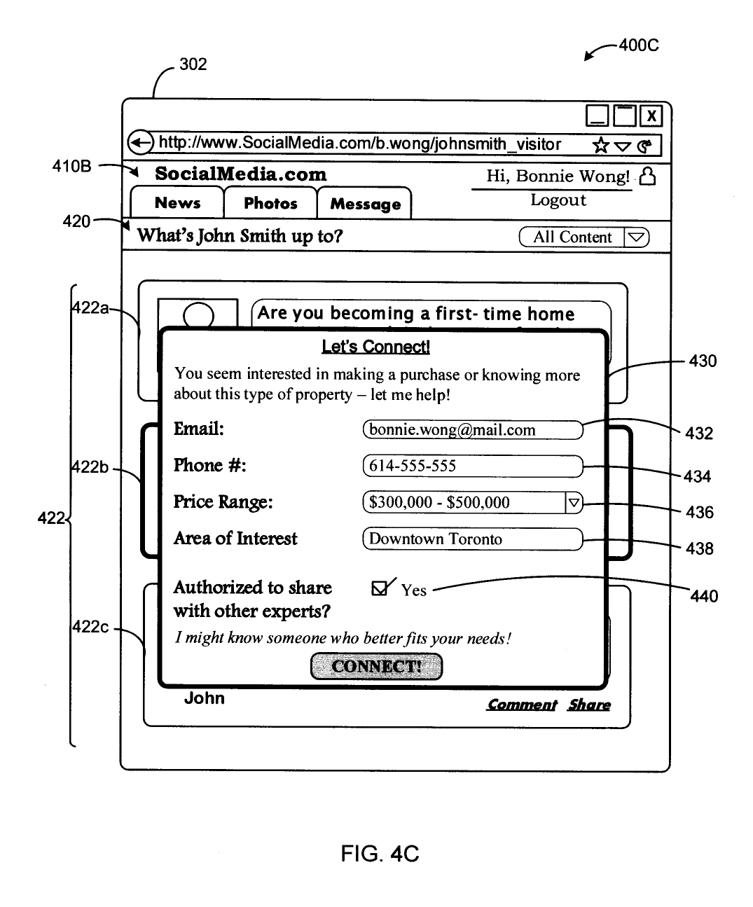

Referring now to FIG. 2, which is a flowchart diagram of an example method 200 of managing social media contents. To illustrate the method 200, reference will be made simultaneously to FIGS. 3 to 4C.

At 210, the processor module 112 receives a subscription request from a subscribing user.

The content system 110 can provide social media contents in accordance with at least the subscription request. As described, in existing social networking systems, the effectiveness of a social media account on any social media network continues to rely, at least, on the ability of the user to create social media presence and to maintain that presence. The content system 110 can help to generate relevant social media contents for the subscribing user so that the subscribing user can appear to have a strong and frequent social media presence.

FIG. 3 is a screenshot 300 of an example subscription interface 310 for receiving the subscription request. The subscription interface 310 is provided via a web browser application 302.

The subscription interface 310 includes various data fields for receiving information related to the subscribing user and the subscription request. As indicated in the name field 312, the subscribing user is “John Smith”. The electronic mail field 314 and the phone number field 316 identify the respective electronic mail address and phone number for the subscribing user.

A subscription level dropdown list 320 is also provided for the subscribing user to select a subscription level. The subscription levels provided by the content system 110 vary based on the different attribution available for use of the interaction tool.

For example, a referral level can indicate that the subscribing user is interested in receiving leads data. The leads data can include user data provided those visiting the subscribing users' social media account and identified by the content system 110 as potential customers for the subscribing user. The processor module 112 may forward the user data collected via the interaction tool to the subscribing user if the subscribing user is at the referral level.

Another example subscription level is a user commission level. The user commission level can indicate that the subscribing user is interested in receiving a commission from any transaction generated from the social media content provided on the social media accounts of the subscribing user.

A subscription level that combines both the referral level and the user commission level may be provided. Other subscription levels may similarly be provided.

The subscription request can also identify one or more categories 330 of social media content in which the subscribing user is interested. Example dropdown lists 332a, 332b are shown in the subscription interface 310 for receiving selections from the subscribing user. In the illustrated example of FIG. 3, the subscribing user is a real estate agent and is interested in receiving social media contents associated with the categories, “Real Estate Listings in Canada” and “Canada Housing Market”. As will be described with reference to FIG. 4A, the content system 110 can automatically generate social media contents within the categories identified in the dropdown lists 332a, 332b for the subscribing user.

Account data corresponding to a set of social media accounts can also be provided as part of the subscription request. As shown in FIG. 3, a social media account within the example social media network, “SocialMedia.com”, is selected from the dropdown list 342 to be linked to the subscription request from the subscribing user. For ease of exposition, only one social media account is shown in FIG. 3 but it will be understood that account data for additional social media accounts can similarly be provided in the subscription request.

At 220, the processor module 112 automatically distributes, without additional input from the subscribing user, at least one social media content to a social media account.

Continuing with the example of FIG. 3, FIG. 4A is a screenshot 400A of an example social media account interface 410A for the subscribing user 402, John Smith. The social media account interface 410A includes a newsfeed 420 for the subscribing user 402. The newsfeed 420 can include postings generated by the subscribing user 402 or by other sources, and other information related to the subscribing user 402 (e.g., status updates, changes in personal information, new connections that were made, etc.).

The newsfeed 420 in FIG. 4A includes social media contents 422, namely 422a to 422c. It will be understood that only three social media contents 422 are shown for ease of exposition and that fewer or more social media contents 422 may generally be provided in a newsfeed.

The social media contents 422 in FIG. 4A are generated by the content system 110 for the subscribing user 402. Each of the social media contents 422 is related to the categories 330 selected in the subscription interface 310 of FIG. 3. With the subscription to the content system 110, the social media account of the subscribing user 402 can appear to be updated fairly regularly with minimal action by the subscribing user 402.

At 230, the processor module 112 tracks an interaction with a user interface associated with the social media account.

FIG. 4B is a screenshot 400B of another example social media account interface 410B. The social media account interface 410B shows the newsfeed 420 of FIG. 4A as viewed by a visitor 404, namely “Bonnie Wong”.

The interaction can include various different actions conducted by the visitor 404 in respect of the social media account interface 410B. Example actions can include navigation of the social media account interface 410B, visits to the social media account interface 410B, any selection of the social media contents 422 within the newsfeed 420, a combination of any of these actions and other similar actions.

In some embodiments, the processor module 112 can collect and maintain data associated with the visitors 404 over multiple visits to the various social media account interfaces 410.

At 240, the processor module 112 generates an interaction tool in response to an event caused by the interaction.

The interaction tool generated by the processor module 112 can vary depending on the event. To generate the interaction tool, the processor module 112 may initiate the interaction application in the applications module 118. Events can occur when the interaction being tracked by the processor module 112 satisfies at least one interaction threshold.

Various example interaction thresholds may be defined by the content system 110 and/or the subscribing user 402. For example, a revisit threshold may indicate a minimum number of visits by the visitor 404 to the social media account interface 410B before the interaction tool can be generated.

In some embodiments, a listing threshold may indicate that any selection of a social media content 422 providing a real estate listing will be considered an event, and the processor module 112 will generate the interaction tool in response. For example, with respect to FIG. 4B, when the visitor 404 selects the social media content 422b, which provides a real estate listing in the Bloor West area, the processor module 112 can generate an interaction tool, such as the example interaction tool 430 shown in FIG. 4C. Other example interaction tools, such as a form component for requesting an appointment to view the real estate listing, may similarly be provided.

FIG. 4C is a screenshot 400C of the interaction tool 430 overlaid on the social media account interface 410B of FIG. 4B. The interaction tool 430 in this example is provided as a form component for receiving user data from the visitor 404. The form component 430 includes various data fields for receiving user data, such as contact information fields (e.g., an electronic mail field 432, a phone number field 434, etc.), real estate listing fields (e.g., a price range field 436, an area of interest field 438, etc.), and other similar fields. In some embodiments, some of the data fields may be prepopulated with data generated based on data provided in the social media content 422b and a user profile of the visitor 404 in the relevant social media network, if available.

The interaction tool 430 may also include an authorization control field 440 for receiving an input indicating that the user data provided by the visitor 404 can be forwarded to others, as determined by the content system 110 and/or the subscribing user 402. As will be described with reference to 250 of FIG. 2, the processor module 112 may determine that the use of the interaction tool 430 by the visitor 404 may be attributed to an individual or entity other than the subscribing user 402.

Another example interaction threshold may require multiple different actions be performed before the processor module 112 generates the interaction tool. The different actions may be performed in respect of contents having a similar subject matter. For example, the processor module 112 may generate the form component 430 after the visitor 404 accesses at least two or more social media contents 422 related to housing in Canada (e.g., the article via the social media content 422a and other contents with a similar subject) and also multiple different real estate listings via the social media account interface 410B (e.g., the real estate listing via the social media content 422b).

In some embodiments, the interaction tool 430 may include a transaction component for receiving transaction data from the visitor 404 for conducting a transaction.

At 250, the processor module 112 attributes use of the interaction tool 430 by the visitor 404.

The processor module 112 can identify a beneficiary of the use of the interaction tool 430 by the visitor 404 based on various factors, such as the configuration of the content system 110, the information provided in the relevant social media content 422, and the subscription level of the subscribing user 402. The beneficiary, in some instances, may be any one of the subscribing user 402, another subscribing user or a content provider of the relevant social media content 422.

Referring again to FIGS. 3 and 4C, the subscribing user 402 is associated with the referral level. Therefore, the processor module 112 can determine that any user data received via the interaction tool 430, such as the form component of FIG. 4C, is to be forwarded to the subscribing user 402 since the subscribing user 402 is in the referral level. The beneficiary of the use of the interaction tool 430, therefore, is the subscribing user 402.

In some embodiments, despite being associated with the referral level, the subscribing user 402 may not be able to help the visitor 404. The subscribing user 402 may be a real estate agent with experience in condominium listings and very little experience with house listings. The subscribing user 402 may indicate within the subscription request, or user preferences stored in the server storage module 116 or the storage module 120, that any user data related to house listings be forwarded to another individual, possibly another subscribing user, with greater experience in the relevant housing market. The subscribing user 402 can, as a result, deepen the business relationship with the individual receiving the referral and may also earn some commission from the referral.

The subscribing user 402 may also indicate in the user preferences stored in the server storage module 116 or the storage module 120 that he is only interested in user data associated with a minimum price range and therefore, to reject any user data provided via the interaction tool 430 that includes a desired price range below the minimum price range. The content system 110 may then automatically forward the leads data to another individual and attribute use of the interaction tool 430 to that individual instead.

In some other embodiments, the processor module 112 can determine that the subscribing user 402 is not within the subscription level at which he can receive the leads data provided via the interaction tool 430. The content system 110 may then forward the user data provided in the form component 430 to a user within the referral level, or perhaps auction or sell the user data to other interested individuals.

In embodiments in which the interaction tool 430 includes a transaction component, the processor module 112 can attribute the use of the interaction tool 430 to the subscribing user 402 when the subscribing user 402 is at the user commission level.

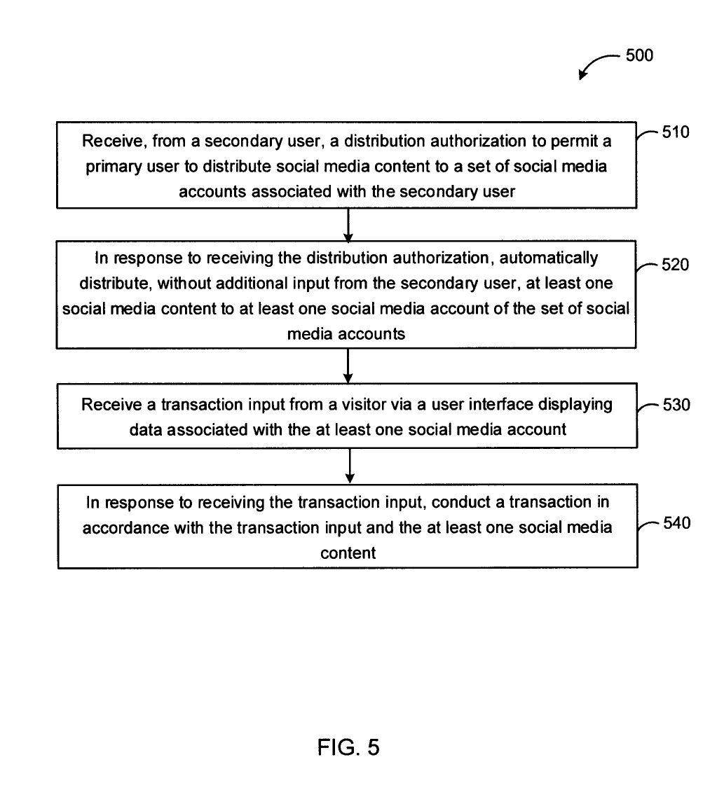

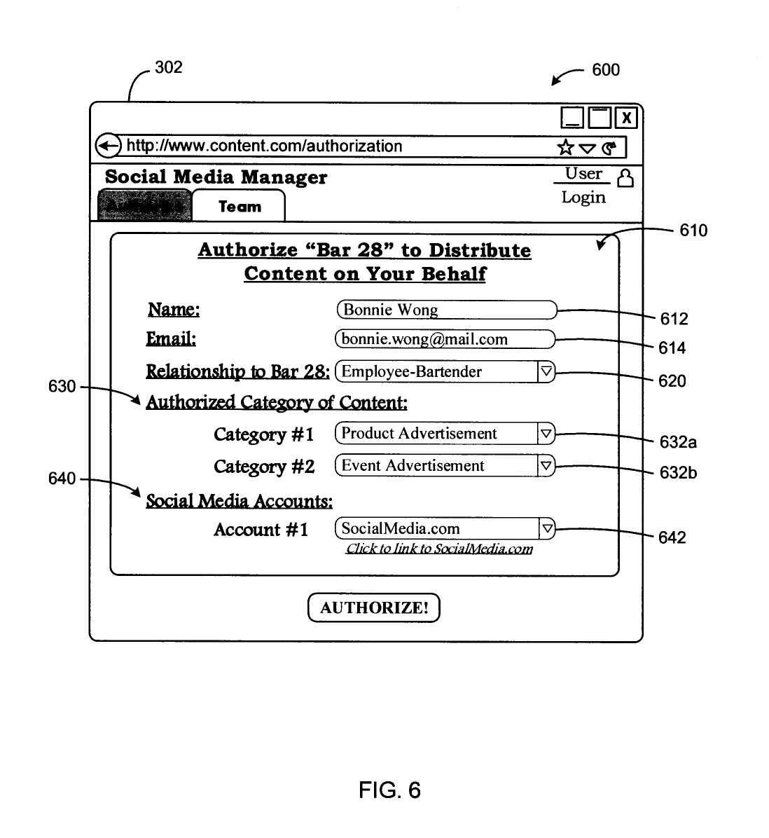

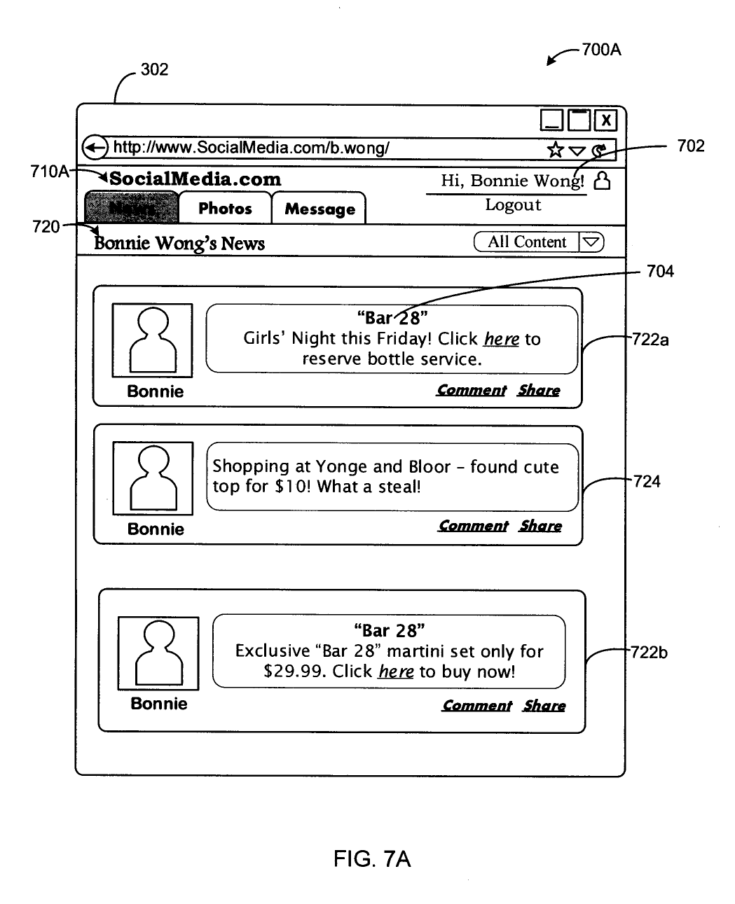

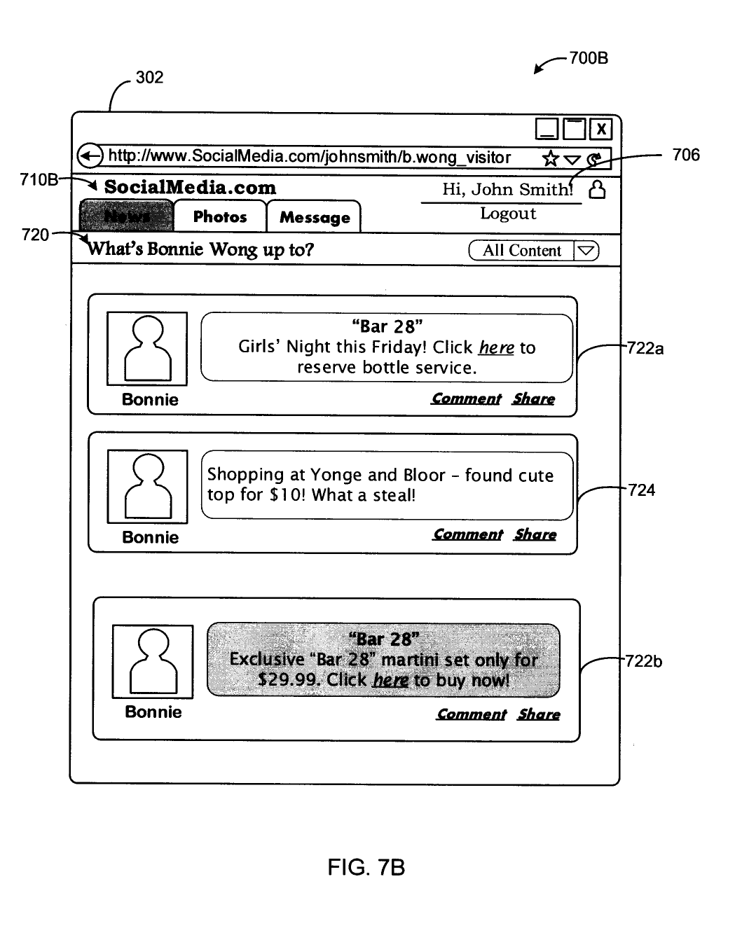

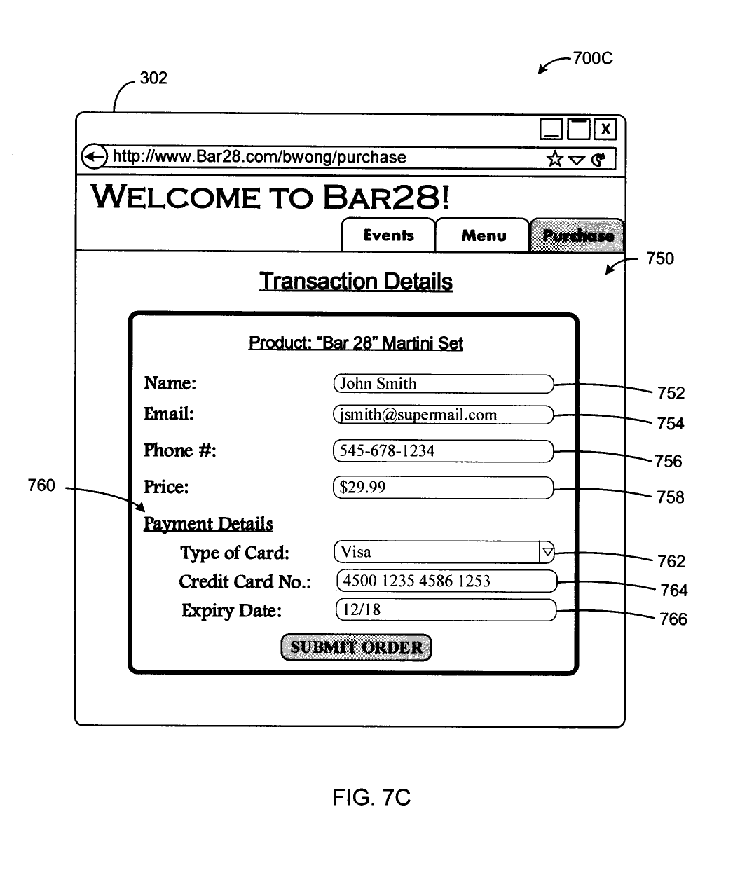

Referring now to FIG. 5, which is a flowchart diagram of another example method 500 of managing social media contents. To illustrate the method 500, reference will be made simultaneously to FIGS. 6 to 7C.

As briefly described, it may sometimes be beneficial for certain users, such as entities, to take advantage of the social media accounts of other users to increase the effectiveness of mass content generation via the social media networks. The social media contents distributed by social media connections can tend to be more influential and trusted than content received from sources outside the social media networks, such as third-party advertisers.

At 510, the processor module 112 receives, from a secondary user, a distribution authorization to permit a primary user to distribute the social media content to a set of social media accounts associated with the secondary user.

FIG. 6 is a screenshot 600 of an example authorization interface 610 for receiving a distribution authorization. Similar to the subscription interface 310 of FIG. 3, the authorization interface 610 is also provided via the web browser application 302.

The authorization interface 610 includes various data fields for receiving permission from a secondary user, such as “Bonnie Wong” (as indicated in the name field 612), authorizing a primary user, such as “Bar 28”, to distribute social media contents to a set of social media accounts associated with the secondary user. The electronic mail field 614 identifies the electronic mail address for the secondary user.

The secondary user is in a hierarchical relationship with the primary user. In the example shown in FIG. 6, the selection in a relationship dropdown list 620 indicates that the secondary user “Bonnie Wong” is an employee of the primary user “Bar 28”. In some embodiments, the secondary user may be the primary user and the primary user may be the secondary user within the same relationship or different relationships.

The distribution authorization can also identify one or more categories 630 of the social media content that the primary user is authorized to distribute to the social media accounts of the secondary user. Example dropdown lists 632a, 632b are shown in the authorization interface 610 for receiving selections from the secondary user. In the illustrated example, the secondary user is a bartender at “Bar 28” and is interested in receiving social media contents associated with the categories, “Product Advertisement” and “Event Advertisement”.

As will be described with reference to FIG. 7A, the content system 110 can automatically distribute social media contents to the social media accounts identified in the authorization interface 610 within the categories identified in the dropdown lists 632a, 632b. The social media contents distributed by the content system 110 may be generated by the primary user “Bar 28”. The social media contents can include data associated with a marketing campaign for the primary user “Bar 28”, such as for a product offered by the primary user or an event hosted by the primary user. Any social media content that does not fall within the identified categories 632a, 632b will not be distributed by the content system 110 to the social media accounts of the secondary user “Bonnie Wong”.

Account data 640 corresponding to a set of social media accounts can also be provided as part of the authorization interface 610. As shown in FIG. 6, a social media account within the example social media network, “SocialMedia.com”, is selected from the dropdown list 642 to be linked to the distribution authorization from the secondary user. For ease of exposition, only one social media account is shown in FIG. 6 but it will be understood that account data for additional social media accounts can similarly be provided in the distribution authorization.

At 520, the processor module 112, in response to receiving the distribution′ authorization, automatically distributes, without additional input from the secondary user, at least one social media content to at least one social media account.

Referring now to FIG. 7A, which is a screenshot 700A of an example social media account interface 710A for the secondary user 702, “Bonnie Wong”. The social media account interface 710A includes a newsfeed 720 for the secondary user 702. The newsfeed 720 can include postings generated by the secondary user 702 and/or by other sources, such as the primary user 704, “Bar 28”, and other information related to the secondary user 702 (e.g., status updates, changes in personal information, new connections that were made, etc.).

The newsfeed 720 in FIG. 7A includes several social media contents 722a, 722b and 724. The social media contents 722a and 722b in FIG. 7A are generated by the primary user 704 and distributed to the social media account of the secondary user 702 on behalf of the secondary user 702. Each of the social media contents 722a and 722b is related to one of the categories 630 selected in the authorization interface 610 of FIG. 6. The social media content 722a is related to an event to be hosted by the primary user 704 and offers visitors of the secondary user's 702 social media account the opportunity to make a reservation. The social media content 722b is related to a product offered by the primary user 704. The social media content 724 is a posting generated by the secondary user 702 and is a status update.

It will be understood that only three social media contents 722a, 722b and 724 are shown for ease of exposition and that fewer or more social media contents 722a, 722b and 724 may generally be provided in a newsfeed.

At 530, the processor module 112 receives a transaction input from a visitor via a user interface displaying data associated with the at least one social media account.

FIG. 7B is a screenshot 700B of another example social media account interface 710B. The social media account interface 710B shows the newsfeed 720 of FIG. 7A as viewed by a visitor 706, namely “John Smith”.

As with any social media account interface, the visitor 706 can navigate the social media account interface 710B and view the various social media contents 722, 724 in the newsfeed 720 for the secondary user 702. The processor module 112 may also receive a transaction input from the visitor 706 in respect of one of the social media contents 722, 724.

Depending on the content of the social media contents 722, 724, the transaction input can include a purchase request or a reservation request. For example, in respect of the social media content 722a, the processor module 112 can receive a transaction input involving a reservation request since the social media content 722a involves an event promotion. The social media content 722b, on the other hand, involves a product promotion. Therefore, any transaction input received by the processor module 112 in respect of the social media content 722b can include a purchase request.

In the example of FIG. 7B, as shown with the shaded social media content 722b, the processor module 112 receives a transaction input from the visitor 706 in respect of the social media content 722b. The visitor 706, therefore, is interested in conducting a purchase transaction in respect of the product being advertised in the social media content 722b.

At 540, the processor module 112, in response to receiving the transaction input, conducts a transaction in accordance with the transaction input and the at least one social media content.

As described, the transaction input can include at least one of a purchase request and a reservation request, depending on the data in the relevant social media content 722, 724. To conduct the transaction, the processor module 112 may initiate the transaction application in the applications module 118. Continuing with the example of FIG. 7B, reference will now be made to FIG. 7C which is a screenshot 700C of an example transaction interface 750.

The transaction interface 750 in this example is for conducting a purchase transaction. The transaction interface 750 may be provided by one or more third party servers 160, such as a payment gateway or a server hosted by the primary user 704. The transaction interface 750 may also be provided via the web browser application 302.

The transaction interface 750 includes various data fields for receiving user data, such as contact information fields (e.g., a name field 752, an electronic mail field 754, a phone number field 756, etc.), a price field 758 and payment information 760 (e.g., a payment type field 762, a credit card identifier field 764, an expiry field 766, etc.). The transaction interface 750 is merely an example interface and it will be understood that other similar fields may be provided in addition or in replacement of some of the illustrated data fields. In some embodiments, some of the data fields may be prepopulated with data generated based on data provided in the social media content 722b and a user profile of the visitor 706 the relevant social media network, if available.

In some embodiments, the processor module 112 can also attribute the transaction to the secondary user 702. For example, the processor module 112 may attribute the transaction to the secondary user 702 by apportioning a portion of a transaction amount to the secondary user 702—that is, the secondary user 702 can earn a commission from the transaction.

As illustrated with the example shown in FIGS. 6 to 7C, the secondary user 702 can benefit from the purchase made by the visitor 706 as a result of authorizing the primary user 704 to distribute social media contents to her social media accounts on her behalf. Apart from providing the distribution authorization shown in FIG. 3, the secondary user 702 had minimal involvement in the content creation and product promotion, but nevertheless is able to share in the purchase amount of the product or reservation. The primary user 704 also benefits from use of the social media account of the secondary user 702 since minimal costs were required apart from the commission provided to the secondary user 702. This feature can be particularly appealing for the primary user 704 since the secondary user 702 may not earn any commission until a transaction takes place as a result of a transaction input being received in respect of a social media content distributed to her social media account.

Various embodiments have been described herein by way of example only. Various modification and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

We claim:

1. A method of managing social media contents, the method comprising:
receiving a subscription request from a subscribing user, the subscription request comprising at least a category of the social media content and account data for a set of social media accounts associated with the subscribing user;
automatically distributing, without additional input from the subscribing user, at least one social media content to at least one social media account of the set of social media accounts, the at least one social media content being associated with the category;
tracking an interaction with a user interface associated with the at least one social media account, the interaction being conducted by a visitor navigating the user interface;
generating an interaction tool in response to an event caused by the interaction, the interaction tool comprising at least one of (i) a form component for receiving user data from the visitor and (ii) a transaction component for receiving transaction data from the visitor for conducting a transaction; and
attributing use of the interaction tool by the visitor.

2. The method of claim 1, wherein:
the subscription request comprises a subscription level of the subscribing user; and
attributing the use of the interaction tool by the visitor comprises selecting a beneficiary based on, at least, the subscription level of the subscribing user.

3. The method of claim 2, wherein the beneficiary is selected from a group consisting of the subscribing user, a second subscribing user, and a content provider providing the social media contents.

4. The method of claim 1, wherein:
the interaction tool is the form component, the form component including one or more data fields for receiving the user data from the visitor and the user data including, at least, contact information of the visitor;
the subscription level comprises a referral level, the referral level indicating the subscribing user is interested in receiving leads data and the leads data comprises the user data for the visitors who are potential leads for the subscribing user; and
attributing the use of the interaction tool by the visitor comprises:
in response to determining the subscription level of the subscribing user is the referral level, selecting the subscribing user as the beneficiary; and
forwarding the user data as the leads information for the subscribing user.

5. The method of claim 1, wherein:
the interaction tool is the transaction component;
the subscription level comprises a user commission level, the user commission level indicating the subscribing user receives a commission from the transaction; and
attributing the use of the interaction tool by the visitor comprises:
in response to determining the subscription level of the subscribing user is the user commission level, selecting the subscribing user as the beneficiary.

6. The method of claim 1, wherein:
the event comprises an interaction threshold; and
generating the interaction tool in response to the event caused by the interaction comprises:
detecting the interaction satisfies the interaction threshold; and
providing the interaction tool on a display providing the user interface.

7. The method of claim 6, wherein the interaction threshold comprises at least a revisit threshold, the revisit threshold corresponding to a minimum number of visits by the visitor to the user interface before the interaction tool is generated.

8. A system for managing social media contents, the system comprising a processor module configured to:
receive a subscription request from a subscribing user, the subscription request comprising at least a category of the social media content and account data for a set of social media accounts associated with the subscribing user;
automatically distribute, without additional input from the subscribing user, at least one social media content to at least one social media account of the set of social media accounts, the at least one social media content being associated with the category;
track an interaction with a user interface associated with the at least one social media account, the interaction being conducted by a visitor navigating the user interface;
generate an interaction tool in response to an event caused by the interaction, the interaction tool comprising at least one of (i) a form component for receiving user data from the visitor and (ii) a transaction component for receiving transaction data from the visitor for conducting a transaction; and
attribute use of the interaction tool by the visitor.

9. The system of claim 8, wherein:
the subscription request comprises a subscription level of the subscribing user; and
the processor module is configured to select a beneficiary based on, at least, the subscription level of the subscribing user.

10. The system of claim 9, wherein the beneficiary is selected from a group consisting of the subscribing user, a second subscribing user, and a content provider providing the social media contents.

11. The system of claim 8, wherein:
the interaction tool is the form component, the form component including one or more data fields for receiving the user data from the visitor and the user data including, at least, contact information of the visitor;
the subscription level comprises a referral level, the referral level indicating the subscribing user is interested in receiving leads data and the leads data comprises the user data for the visitors who are potential leads for the subscribing user; and
the processor module is configured to:
in response to determining the subscription level of the subscribing user is the referral level, select the subscribing user as the beneficiary; and
forward the user data as the leads information for the subscribing user.

12. The system of claim 8, wherein:
the interaction tool is the transaction component;
the subscription level comprises a user commission level, the user commission level indicating the subscribing user receives a commission from the transaction; and
the processor module is configured, in response to determining the subscription level of the subscribing user is the user commission level, select the subscribing user as the beneficiary.

13. The system of claim 8, wherein:
the event comprises an interaction threshold; and
the processor module is configured to:
detect the interaction satisfies the interaction threshold; and
provide the interaction tool on a display providing the user interface.

14. The system of claim 13, wherein the interaction threshold comprises at least a revisit threshold, the revisit threshold corresponding to a minimum number of visits by the visitor to the user interface before the interaction tool is generated.

15. A method of managing social media content, the method comprising:
receiving a distribution authorization from a secondary user, the distribution authorization providing a primary user with permission to distribute the social media content to a set of social media accounts associated with the secondary user and the secondary user being in a hierarchical relationship with the primary user;
in response to receiving the distribution authorization, automatically distributing, without additional input from the secondary user, at least one social media content to at least one social media account of the set of social media accounts;
receiving a transaction input from a visitor via a user interface displaying data associated with the at least one social media account, the visitor being a user navigating the user interface and the transaction input being associated with the at least one social media content; and
in response to receiving the transaction input, conducting a transaction in accordance with the transaction input and the at least one social media content, wherein conducting the transaction comprises attributing the transaction to the secondary user.

16. The method of claim 15, wherein attributing the transaction to the secondary user comprises apportioning a portion of a transaction amount to the secondary user.

17. The method of claim 15, wherein the social media content comprises content associated with a marketing campaign for the primary user.

18. The method of claim 17, wherein:
the marketing campaign involves an advertisement of a product;
the transaction input comprises a purchase request for the product; and
conducting the transaction comprises:
fulfilling the purchase request; and
apportioning a portion of a purchase amount to the secondary user.

19. The method of claim 17, wherein:
the marketing campaign involves an advertisement of an event;
the transaction input comprises at least one of a purchase request associated with the event and a reservation request for the event; and
conducting the transaction comprises:
fulfilling the at least one of the purchase request and the reservation request; and
apportioning a portion of a transaction amount to the secondary user.

20. The method of claim 15, wherein the primary user is an employer of the secondary user.
